(19) United States
(12) Patent Application Publication
(10) Pub. No.: US 2025/0349482 A1
(43) Pub. Date: Nov. 13, 2025

(54) ASSEMBLING AN ELECTROMECHANICAL SWITCHING DEVICE TO MINIMIZE AIR GAPS IN MAGNETIC CIRCUIT PATHWAYS

(71) Applicant: SENSATA TECHNOLOGIES, INC., ATTLEBORO, MA (US)

(72) Inventors: MATTHEW CHARLES RYDER, HOLLISTON, MA (US); ALESSANDRA ROSE PAOLUCCI, BOSTON, MA (US)

(21) Appl. No.: 18/657,275

(22) Filed: May 7, 2024

(51) Int. Cl. H01H 50/36; H01H 50/44; H01H 50/54

(52) U.S. Cl. CPC H01H 50/36; H01H 50/44; H01H 50/54

(57) ABSTRACT

In a particular embodiment, a method of assembling an electromechanical switching device is disclosed that includes partially inserting a lower static core into a core cavity of a coil assembly having a plurality of components including a plunger assembly enclosure and a coil enclosure. In this embodiment, the core cavity is formed by the plunger assembly enclosure and the coil enclosure. The method also includes positioning the coil assembly within a coil yoke and pushing the coil assembly into the coil yoke such that the lower static core is fully inserted in the core cavity.

### FIELD OF THE TECHNOLOGY

The subject disclosure relates to assembling an electromechanical switching device to minimize air gaps in magnetic circuit pathways of the electromechanical switching device.

### BACKGROUND

Electromechanical switching devices, such as contactors and relays, are pivotal components within electrical systems, tasked with efficiently managing the flow of electrical current over specified durations. These devices feature a dynamic assembly responsible for the opening and closing of electrical circuits. Central to their functionality are magnetic circuits, integrated to guide and harness the electromagnetic fields generated by the device's coils. This magnetic field serves as the driving force behind the actuation of the switching device.

Traditionally, constructing the magnetic circuitry of electromechanical switching devices involves assembling multiple components to form a cohesive pathway. However, variations introduced during manufacturing and assembly inevitably lead to the formation of unavoidable air gaps between these components. Despite the cost-effective benefits of looser tolerances in component selection and manufacturing, utilizing multiple components increases the likelihood of air gap occurrence. Air gaps are an issue because magnetic flux lines strongly prefer flowing through steel rather than air, with a preference factor ranging from 100 to over 10,000 depending on the steel grade. Air gaps allow flux lines to escape, forcing the remaining lines through a smaller cross-sectional area, potentially saturating the material and limiting magnetic force. Reduced magnetic forces can result in higher contact resistance and compromised performance, especially under high temperatures.

For instance, FIG. 1 depicts a cross-sectional view of an electromechanical switching device 100 featuring a coil yoke with a base section 106 and upward-extending arms 140 surrounding a coil assembly 190. During assembly, the coil assembly 190 is inserted into the coil yoke, with the arms 140 intended to be fastened to an upper plate 108. In this example, the arms 140 are too long, creating a gap 199 between the coil assembly 190 and the base section 106, consequently reducing performance and potentially causing rattling during application.

In another example illustrated in FIG. 2, an electromechanical switching device 200 includes a coil yoke with a base section 206 and arms 240 that are too short, resulting in a gap 299 between an upper plate 208 and the arms 240. This gap compromises magnetic efficiency and device performance while increasing yield loss during welding.

As these examples show, the challenge lies in joining multiple components in a cost-effective manner without introducing air gaps that degrade circuit performance or incurring significant costs for precision components.

### SUMMARY

This disclosure presents apparatuses, systems, devices, and methods designed to minimize air gaps during the assembly of electromechanical switching devices. According to at least one embodiment of the present disclosure, during initial assembly, a lower static core of the electromechanical switching device is positioned out of its final assembly location. Through precise insertion operations during assembly, the proposed solution enables the seamless integration of components during assembly and minimizes air gaps in magnetic circuit pathways of the electromechanical switching device. Reducing the occurrence of air gaps between components enhances the magnetic force generated by the coil and thus increasing the performance and reliability of the electromechanical switching device.

In a particular embodiment, a method of assembling an electromechanical switching device is disclosed that includes partially inserting a lower static core into a core cavity of a coil assembly having a plurality of components including a plunger assembly enclosure and a coil enclosure. In this embodiment, the core cavity is formed by the plunger assembly enclosure and the coil enclosure. The method also includes positioning the coil assembly within a coil yoke and pushing the coil assembly into the coil yoke such that the lower static core is fully inserted in the core cavity.

In another embodiment, an apparatus is disclosed that includes a coil yoke having a base section with a plurality of holes for holding a plunger assembly enclosure and a coil enclosure. In this embodiment, the coil yoke has arms extending from the base section such that external sides of the arms flare outwards from the base section at an angle from a line extending perpendicular to a plane formed by a surface of the base section.

In another embodiment, an electromechanical switching device apparatus is disclosed that includes a lower static core and a coil assembly having a plurality of components including a plunger assembly enclosure and a coil enclosure. In this embodiment, the coil assembly includes a core cavity for insertion of the lower static core. The core cavity is formed by the plunger assembly enclosure and the coil enclosure. The apparatus also includes a coil yoke having a base section with a plurality of holes for holding the plunger assembly enclosure and the coil enclosure. In this embodiment, the coil yoke has arms extending from the base section such that external sides of the arms flare outwards from the base section at an angle from a line extending perpendicular to a plane formed by a surface of the base section.

As will be explained further below, incorporating a coil yoke with arms featuring a predetermined outward bend in the assembly of an electromechanical switching device facilitates enhanced component integration through precise bending procedures during assembly. This, in turn, enhances the performance and reliability of the assembled electromechanical switching device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram illustrating a cross-sectional view of an electromechanical switching device with a coil yoke having arms that are too long.

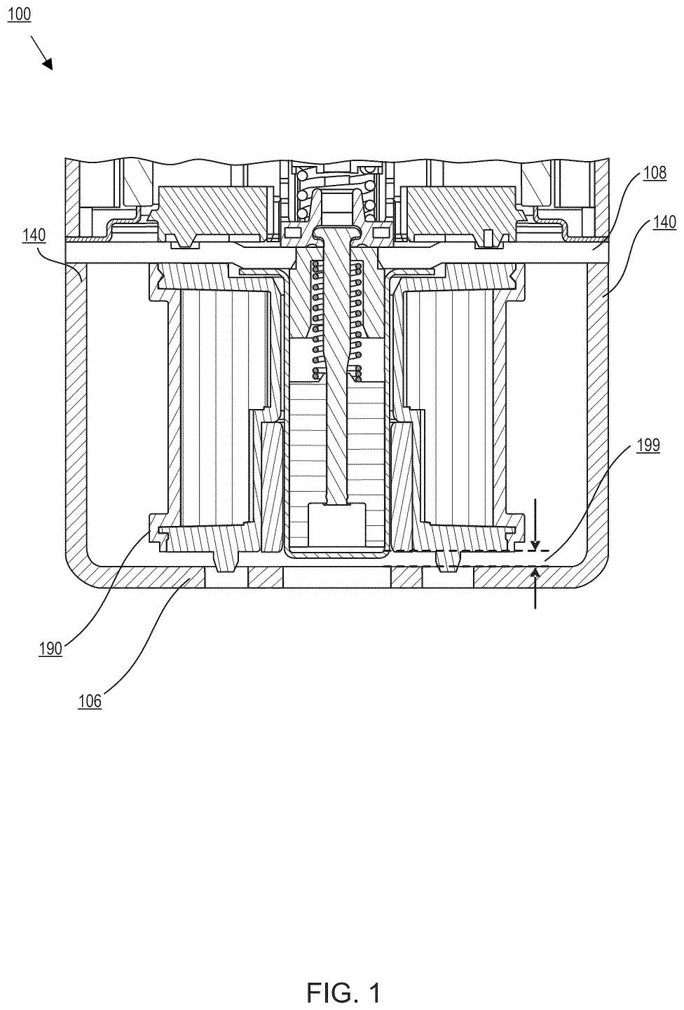

FIG. 2 is a diagram illustrating a cross-sectional view of another electromechanical switching device with a coil yoke having arms that are too short.

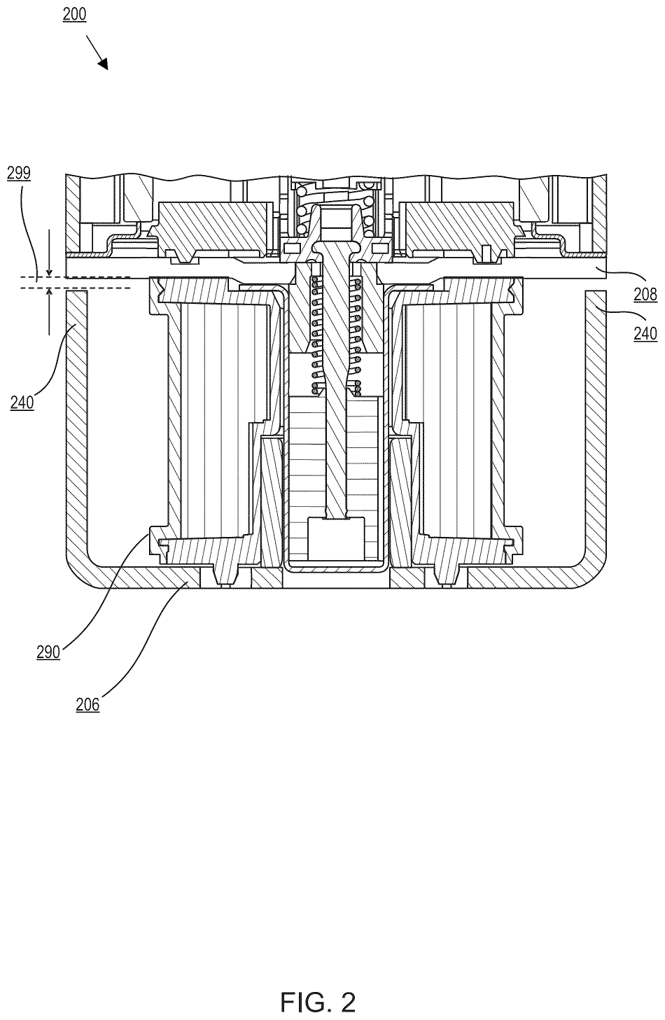

FIG. 3A is a diagram illustrating a cross-sectional view of an electromechanical switching device assembly including a coil yoke having arms with a predetermined outward bend and positioned in accordance with at least one assembly process embodiment of the present disclosure.

FIG. 3B is a diagram illustrating a cross-sectional view of the electromechanical switching device assembly of FIG. 3A with the coil yoke arms compressed in accordance with at least one assembly process embodiment of the present disclosure.

FIG. 3C is a diagram illustrating a cross-sectional view of the electromechanical switching device assembly of FIG. 3A with the components positioned and fastened in accordance with at least one assembly process embodiment of the present disclosure.

FIG. 3D is a diagram illustrating a cross-sectional view of the electromechanical switching device assembly of FIG. 3A assembled in accordance with at least one assembly processes embodiment of the present disclosure.

FIG. 4 is a method of assembling an electromechanical switching device according to at least one embodiment of the present disclosure.

FIG. 5 is another method of assembling an electromechanical switching device according to at least one embodiment of the present disclosure.

FIG. 6 is another method of assembling an electromechanical switching device according to at least one embodiment of the present disclosure.

FIG. 7 is another method of assembling an electromechanical switching device according to at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

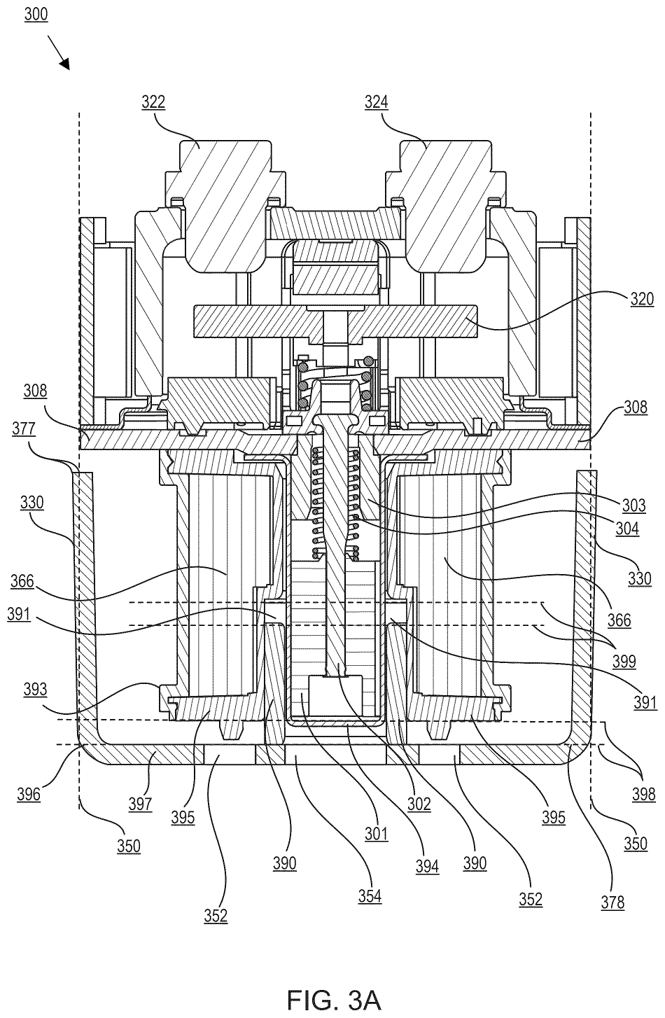

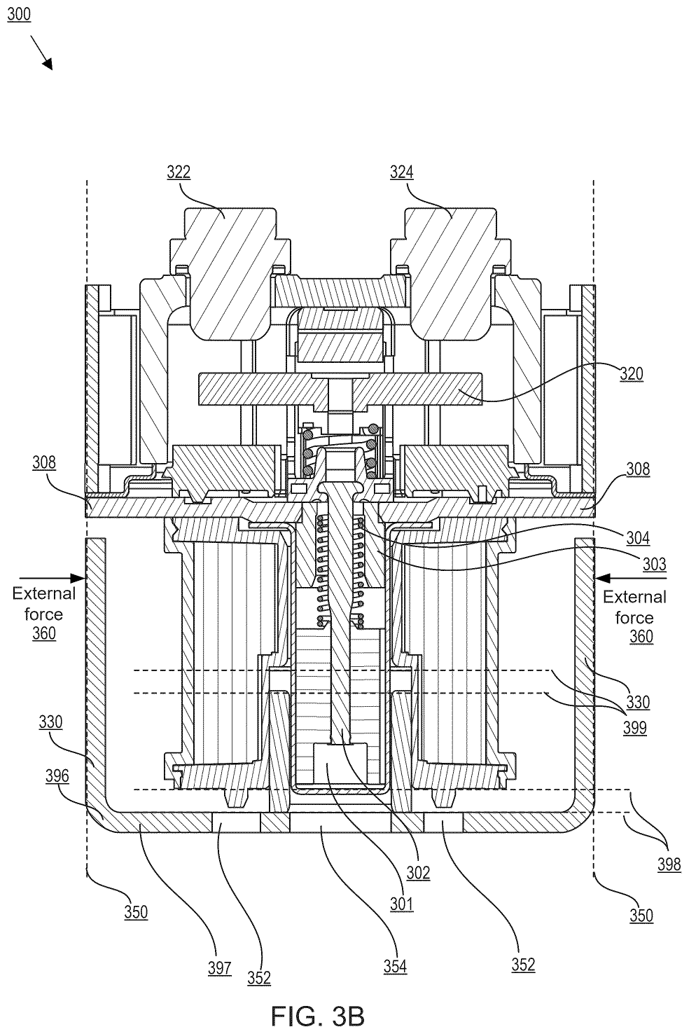

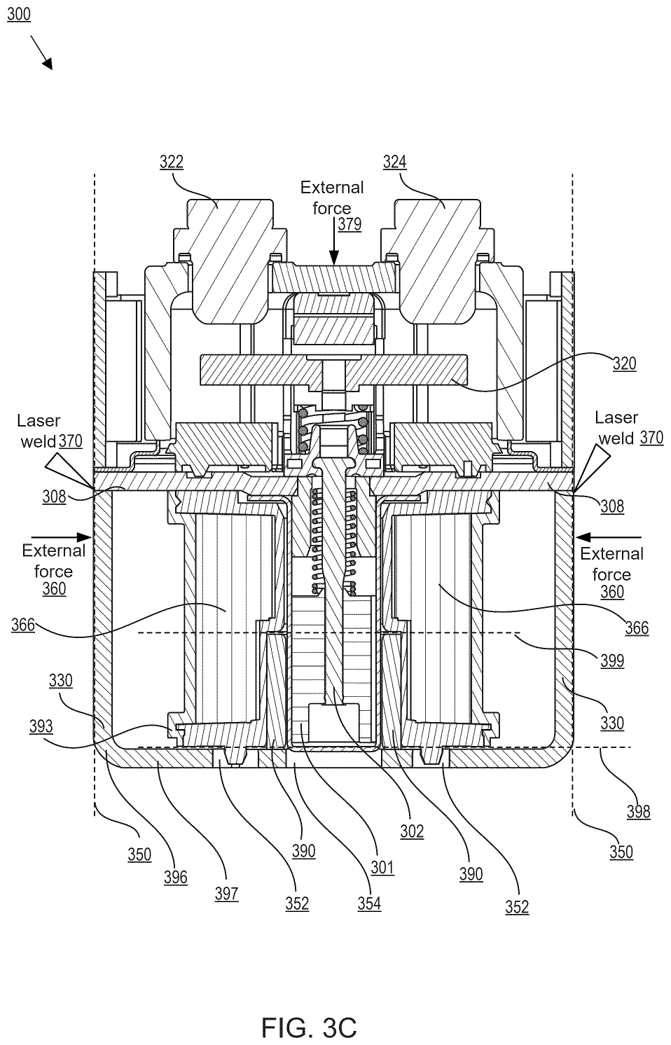

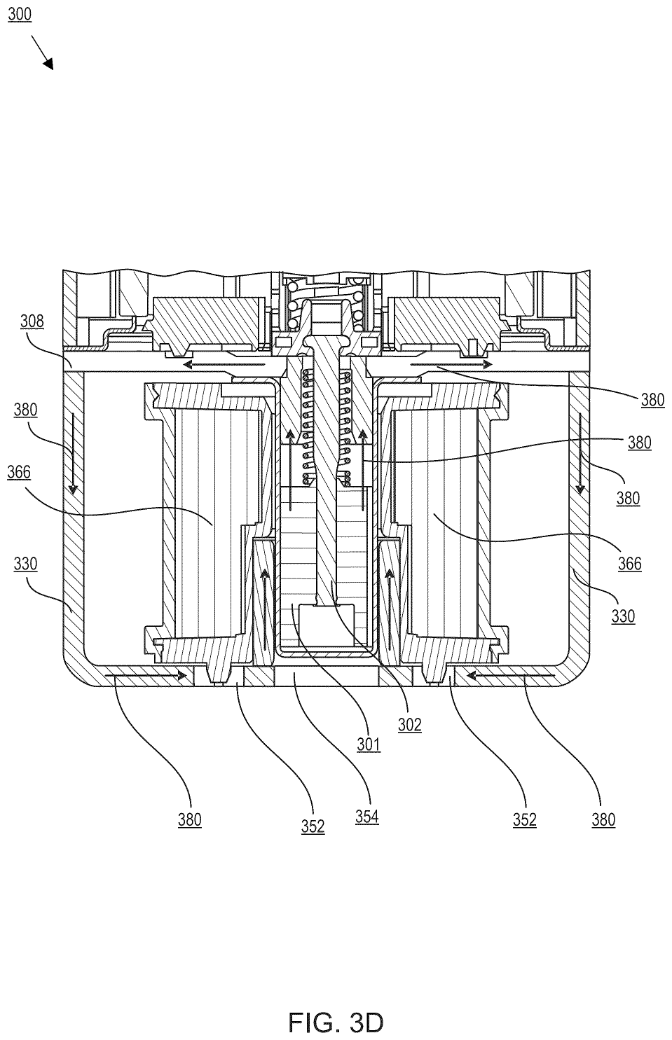

For further explanation, FIG. 3A sets forth a diagram illustrating a cross-sectional view of an electromechanical switching device assembly 300 including a coil yoke 396 having arms 330 with a predetermined outward bend and positioned in accordance with at least one assembly process embodiment of the present disclosure. The arms 330 flare outwards from a base section 397 of the coil yoke 396 at an angle 377 from a line 350 extending perpendicular to a plane 378 formed by a surface of the base section 397.

In the example of FIG. 3A, the coil yoke surrounds a coil assembly 393 that includes a plunger assembly enclosure 394 and a coil enclosure 395. The base section 397 of the coil yoke 396 includes a plurality of holes 352, 354 for holding the plunger assembly enclosure 394 and the coil enclosure 395. The coil enclosure 395 surrounds a coil 366 and the plunger assembly enclosure 394 surrounds a plunger assembly having a plunger 301 coupled to a plunger shaft 302. The switching device assembly 300 further includes an upper plate 308 that is coupled to flange 303. In the example of FIG. 3A, a plunger spring 304 is coupled between the flange 303 and the plunger 301. The switching device assembly 300 also includes fixed contacts 322, 324 and a moveable contact 320. As will be explained further below, the moveable contact 320 is configured to create or break the connection between the fixed contacts 322, 324 in response to movement of the plunger assembly.

In the example of FIG. 3A, a core cavity 391 is formed in the coil assembly 393 between the plunger assembly enclosure 394 and the coil enclosure 395. In a particular embodiment of an assembly process, a lower static core 390 is partially inserted into the core cavity 391 of the coil assembly 393, such that there is a gap 399 between the end of the lower static core 390 and the back of the core cavity 391. In this state of assembly, the coil assembly 393 is positioned within the coil yoke 396 but not fully inserted so that there is a gap 398 between the coil assembly 393 and the base section 397 of the coil yoke 396.

For further explanation, FIG. 3B sets forth a diagram illustrating a cross-sectional view of the electromechanical switching device assembly 300 of FIG. 3A with the coil yoke arms 330 compressed in accordance with at least one assembly process embodiment of the present disclosure. For ease of illustration, not all of the components of the switching device assembly 300 are labeled and references in FIGS. 3B-D.

In the example of FIG. 3B, an external force 360 is applied to sides of the arms 330 of the coil yoke 396 such that external surfaces of the sides of the arms 330 of the coil yoke 396 are parallel to the line 350 extending perpendicular to the plane formed by the surface of the base section 397.

For further explanation, FIG. 3C sets forth a diagram illustrating a cross-sectional view of the electromechanical switching device assembly 300 of FIG. 3A with the components positioned and fastened in accordance with at least one assembly process embodiment of the present disclosure. In the example of FIG. 3C, an external force 379 is applied to the top of the switching device assembly 300 which causes the coil assembly 393 to be pushed into the coil yoke 396 such that the lower static core 390 is fully inserted in the core cavity 391. For example, the gap 399 between the end of the lower static core 390 and the back of the core cavity 391 is reduced or eliminated. Also, the gap 398 between the coil assembly 393 and the base section 397 of the coil yoke 396 is reduced or eliminated.

After the coil assembly is fully pushed into the coil yoke, the arms 330 of the coil yoke 396 are fastened to an upper plate 308 that is coupled to the coil assembly 393. For example, the upper plate and the arms of the coil yoke may be laser welded 370 together.

For further explanation, FIG. 3D is a diagram illustrating a cross-sectional view of the electromechanical switching device assembly 300 of FIG. 3A assembled in accordance with at least one assembly processes embodiment of the present disclosure. In the fully assembled state of FIG. 3D, all component tolerances are compensated for, effectively eliminating air gaps in magnetic circuit pathways of the electromechanical switching device. By intentionally biasing these components in a correctable direction during assembly, rather than solely relying on manufacturing tolerances for final positioning, the proposed solution enables the seamless integration of components during assembly, eliminating compatibility issues in fit and minimizing air gaps in the magnetic circuit. This approach enhances the magnetic force generated by the coil 366 while maintaining a consistent power consumption level, resulting in optimal performance and reliability in the assembled electromechanical switching device.

Referring to components described in FIGS. 3A-C, during operation in the open state, no current flows between the fixed contacts 322, 324. The plunger spring 304 is configured to apply a pre-load force on the plunger 301 to prevent the plunger assembly from moving to a closed state. In the closed state, where the moveable contact 320 contacts the fixed contacts 322, 324, current flows between the fixed contacts 322, 324 through the moveable contact 320. The moveable contact 320 is moved by the plunger assembly. When the coil 366, such as a solenoid actuator, is energized, a magnetic field 380 is created that flows through the magnetic circuit pathways of the electromechanical switching device assembly. The magnetic field 380 forces the plunger 301 with upper direction. If the force is bigger than the pre-load force from the plunger spring 304, the plunger 301 begins to move towards the flange 303. The plunger 301 and the flange 303 have corresponding interfaces configured for magnetically attracting the flange and the plunger in response to application of an electric current to the coil. The plunger 301 and the plunger shaft 302 drive the moveable contact 320 toward the fixed contacts 322, 324 until the moveable contact 320 is in a closed position in which contact is established between the moveable contact 320 and the fixed contacts 322, 324, thus transitioning the switching device assembly 300 from the open state to the closed state. The movement of the plunger 301 compresses the plunger spring 304.

The coil is positioned such that when the electric current to the coil is removed, a force of energy stored in the plunger spring drives the plunger away from the flange. That is, when the coil 366 is de-energized, the plunger 301 is driven downward from the force of the energy stored in the compressed plunger spring 304, and the plunger assembly pulls the moveable contact 320 downward until the moveable contact 320 is in an open position, thus breaking contact between the moveable contact 320 and the fixed contacts 322, 324. In this example, the plunger spring 304 provides sufficient force load that prevents all moveable parts from moving. The high holding force is needed to achieve high shock resistance in the closed state.

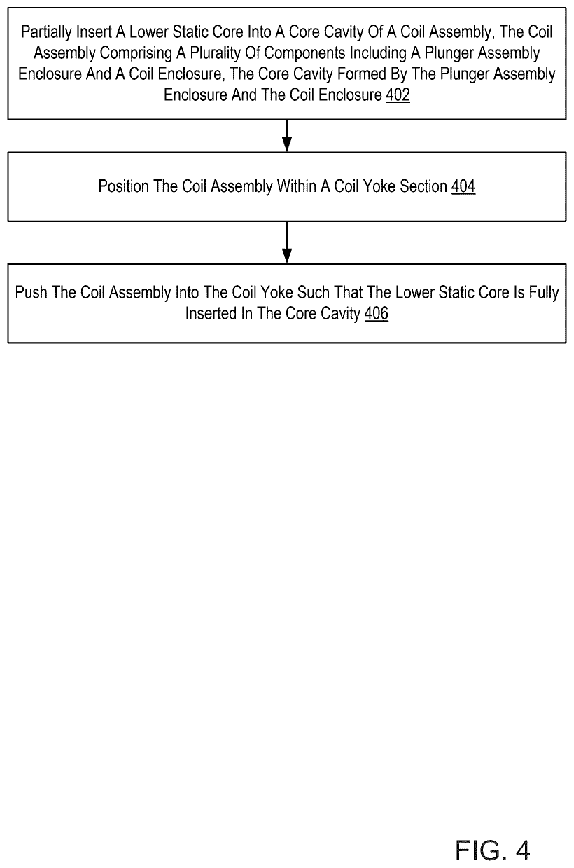

For further explanation, FIG. 4 sets forth a diagram illustrating a method of assembling an electromechanical switching device according to at least one embodiment of the present disclosure. As explained above, assembling an electromechanical switching device may include coupling a plurality of components together. Traditionally, variations introduced during manufacturing and assembly inevitably lead to the formation of unavoidable air gaps between these components. The method of FIG. 4 recites a method of assembling the device that results in an assembled device in which air gaps are eliminated or significantly reduced.

The method of FIG. 4 includes partially inserting 402 a lower static core into a core cavity of a coil assembly. As illustrated in FIG. 3A, the coil assembly includes a plurality of components, such as a plunger assembly enclosure and a coil enclosure. In this embodiment, the core cavity is formed by the plunger assembly enclosure and the coil enclosure.

The method of FIG. 4 also includes positioning 404 the coil assembly within a coil yoke. In addition, the method of FIG. 4 also includes pushing 406 the coil assembly into the coil yoke such that the lower static core is fully inserted in the core cavity. As shown in FIG. 3C, an external force may be applied to top of the switching device which causes the lower static core to be pressed into the base section of the coil yoke, which in turn causes the lower static core to be further inserted into the core cavity. Pushing the top of the switching device also causes the plunger assembly enclosure and coil enclosure to be pressed in the base section of the coil yoke.

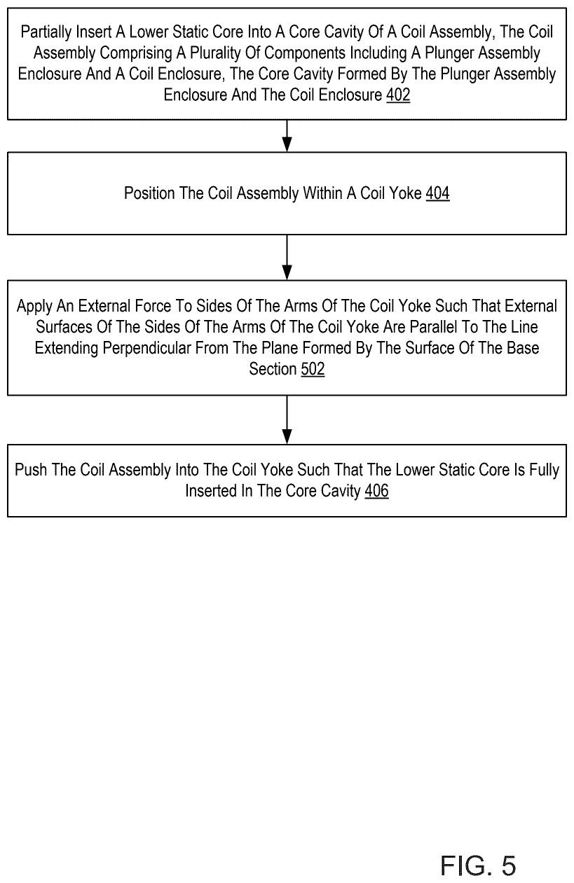

For further explanation, FIG. 5 is another method of assembling an electromechanical switching device according to at least one embodiment of the present disclosure. In the method of FIG. 5 and as illustrated in FIG. 3A, the coil yoke has a base section with a plurality of holes for holding the plunger assembly enclosure and the coil enclosure. In the example of FIG. 3A, the coil yoke also has arms with a predetermined outward bend that extend from the base section such that external sides of the arms flare outwards from the base section at an angle from a line extending perpendicular to a plane formed by a surface of the base section. The example method of FIG. 5 extends the method of FIG. 4 in that the method of FIG. 5 includes applying 502 an external force to sides of the arms of the coil yoke such that external surfaces of the sides of the arms of the coil yoke are parallel to the line extending perpendicular from the plane formed by the surface of the base section. As shown in FIG. 3C, external forces 360, 379 may be applied to the sides of the coil yoke and on the top of the switching device, to form a configuration that is ready for permanent fastening.

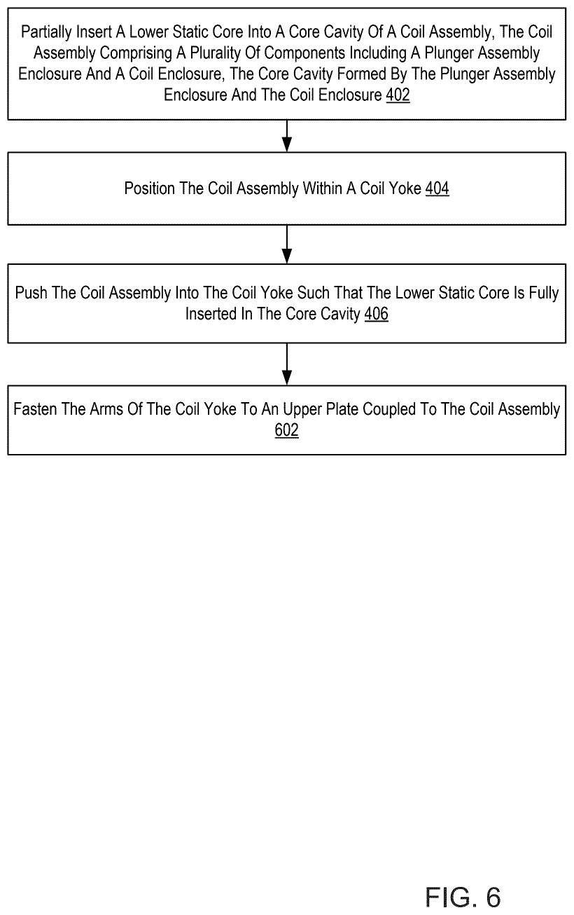

For further explanation, FIG. 6 is another method of assembling an electromechanical switching device according to at least one embodiment of the present disclosure. The example method of FIG. 6 extends the method of FIG. 4 in that the method of FIG. 6 includes fastening 602 the arms of the coil yoke to an upper plate coupled to the coil assembly. Fastening 602 the arms of the coil yoke to the upper plate coupled to the coil assembly may be carried out by welding, applying glue or adhesive, or any other method of coupling the components of the switching device together.

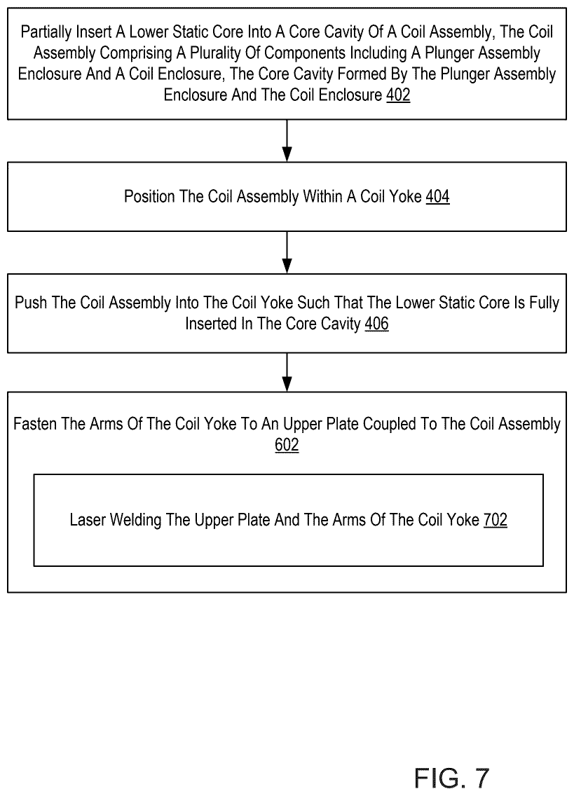

For further explanation, FIG. 7 is another method of assembling an electromechanical switching device according to at least one embodiment of the present disclosure. The example method of FIG. 7 extends the method of FIG. 6 in that in the method of FIG. 7, fastening 602 the arms of the coil yoke to an upper plate coupled to the coil assembly includes laser welding 702 the upper plate and the arms of the coil yoke. For example, FIG. 3D illustrates a laser weld 370 coupling the upper plate 308 and the arms 330 of the coil yoke 396.

Advantages and features of the present disclosure can be further described by the following statements:
1. A method of assembling an electromechanical switching device, the method comprising: partially inserting a lower static core into a core cavity of a coil assembly, the coil assembly comprising a plurality of components including a plunger assembly enclosure and a coil enclosure, the core cavity formed by the plunger assembly enclosure and the coil enclosure; positioning the coil assembly within a coil yoke; and pushing the coil assembly into the coil yoke such that the lower static core is fully inserted in the core cavity.
2. The method of statement 1, wherein the coil yoke has a base section with a plurality of holes for holding the plunger assembly enclosure and the coil enclosure; wherein the coil yoke has arms extending from the base section such that external sides of the arms flare outwards from the base section at an angle from a line extending perpendicular to a plane formed by a surface of the base section.

3. The method of statements 1 or 2 further comprising applying an external force to sides of the arms of the coil yoke such that external surfaces of the sides of the arms of the coil yoke are parallel to the line extending perpendicular from the plane formed by the surface of the base section.
4. The method of any of statements 1-3 further comprising fastening the arms of the coil yoke to an upper plate coupled to the coil assembly.
5. The method of any of statements 1-4, wherein fastening the upper plate to the arms of the coil yoke includes laser welding the upper plate and the arms of the coil yoke.
6. The method of any of statements 1-5, wherein the coil assembly includes a solenoid surrounding the plunger assembly enclosure.
7. The method of any of statements 1-6, wherein the upper plate is coupled to a flange that is partially within the plunger assembly enclosure.
8. The method of any of statements 1-7, wherein the plunger assembly enclosure surrounds a plunger assembly.
9. The method of any of statements 1-8, wherein the plunger assembly includes a plunger shaft coupled to a plunger.
10. The method of any of statements 1-9, wherein the plunger assembly includes a plunger spring coupled to the flange and the plunger.
11. The method of any of statements 1-10, wherein the plunger spring is configured to apply a preload force on the plunger to prevent the plunger assembly from moving to a closed state.
12. The method of any of statements 1-11, wherein the plunger and the flange have corresponding interfaces configured for magnetically attracting the flange and the plunger in response to application of an electric current to a coil of the coil assembly.
13. The method of any of statements 1-12, wherein the coil is positioned such that when the electric current to the coil is removed, a force of energy stored in the plunger spring drives the plunger away from the flange.
14. The method of any of statements 1-13, wherein the electromechanical switching device further includes: a plurality of stationary contacts; and a moveable contact coupled to a plunger shaft and configured to engage with the plurality of stationary contacts in a closed position.
15. An apparatus comprising: a coil yoke, the coil yoke having a base section with a plurality of holes for holding a plunger assembly enclosure and a coil enclosure; the coil yoke having arms extending from the base section such that external sides of the arms flare outwards from the base section at an angle from a line extending perpendicular to a plane formed by a surface of the base section.
16. An electromechanical switching device apparatus comprising: a lower static core; a coil assembly comprising a plurality of components including a plunger assembly enclosure and a coil enclosure, the coil assembly including a core cavity for insertion of the lower static core, the core cavity formed by the plunger assembly enclosure and the coil enclosure; and a coil yoke having a base section with a plurality of holes for holding the plunger assembly enclosure and the coil enclosure; the coil yoke having arms extending from the base section such that external sides of the arms flare outwards from the base section at an angle from a line extending perpendicular to a plane formed by a surface of the base section.
17. The apparatus of statement 16, wherein the coil assembly includes a solenoid surrounding the plunger assembly enclosure.
18. The apparatus of statements 16 or 17 further comprising a plunger assembly that includes a plunger shaft coupled to a plunger.
19. The apparatus of any of statements 16-18, wherein the plunger assembly includes a plunger spring configured to apply a preload force on the plunger to prevent the plunger assembly from moving to a closed state.
20. The apparatus of any of statements 16-19, wherein the plunger and a flange have corresponding interfaces configured for magnetically attracting the flange and the plunger in response to application of an electric current to a coil of the coil assembly; and wherein the coil is positioned such that when application of the electric current to the coil is removed, a force of energy stored in a plunger spring drives the plunger away from the flange.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of assembling an electromechanical switching device, the method comprising:
partially inserting a lower static core into a core cavity of a coil assembly, the coil assembly comprising a plurality of components including a plunger assembly enclosure and a coil enclosure, the core cavity formed by the plunger assembly enclosure and the coil enclosure;
positioning the coil assembly within a coil yoke; and
pushing the coil assembly into the coil yoke such that the lower static core is fully inserted in the core cavity.

2. The method of claim 1, wherein the coil yoke has a base section with a plurality of holes for holding the plunger assembly enclosure and the coil enclosure; wherein the coil yoke has arms extending from the base section such that external sides of the arms flare outwards from the base section at an angle from a line extending perpendicular to a plane formed by a surface of the base section.

3. The method of claim 2 further comprising applying an external force to sides of the arms of the coil yoke such that external surfaces of the sides of the arms of the coil yoke are parallel to the line extending perpendicular from the plane formed by the surface of the base section.

4. The method of claim 2 further comprising fastening the arms of the coil yoke to an upper plate coupled to the coil assembly.

5. The method of claim 4 wherein fastening the upper plate to the arms of the coil yoke includes laser welding the upper plate and the arms of the coil yoke.

6. The method of claim 1, wherein the coil assembly includes a solenoid surrounding the plunger assembly enclosure.

7. The method of claim 4, wherein the upper plate is coupled to a flange that is partially within the plunger assembly enclosure.

8. The method of claim 7, wherein the plunger assembly enclosure surrounds a plunger assembly.

9. The method of claim 8, wherein the plunger assembly includes a plunger shaft coupled to a plunger.

10. The method of claim 9, wherein the plunger assembly includes a plunger spring coupled to the flange and the plunger.

11. The method of claim 10, wherein the plunger spring is configured to apply a preload force on the plunger to prevent the plunger assembly from moving to a closed state.

12. The method of claim 10, wherein the plunger and the flange have corresponding interfaces configured for magnetically attracting the flange and the plunger in response to application of an electric current to a coil of the coil assembly.

13. The method of claim 12, wherein the coil is positioned such that when the electric current to the coil is removed, a force of energy stored in the plunger spring drives the plunger away from the flange.

14. The method of claim 1, wherein the electromechanical switching device further includes:
a plurality of stationary contacts; and
a moveable contact coupled to a plunger shaft and configured to engage with the plurality of stationary contacts in a closed position.

15. An apparatus comprising:
a coil yoke, the coil yoke having a base section with a plurality of holes for holding a plunger assembly enclosure and a coil enclosure; the coil yoke having arms extending from the base section such that external sides of the arms flare outwards from the base section at an angle from a line extending perpendicular to a plane formed by a surface of the base section.

16. An electromechanical switching device apparatus comprising:
a lower static core;
a coil assembly comprising a plurality of components including a plunger assembly enclosure and a coil enclosure, the coil assembly including a core cavity for insertion of the lower static core, the core cavity formed by the plunger assembly enclosure and the coil enclosure; and
a coil yoke having a base section with a plurality of holes for holding the plunger assembly enclosure and the coil enclosure; the coil yoke having arms extending from the base section such that external sides of the arms flare outwards from the base section at an angle from a line extending perpendicular to a plane formed by a surface of the base section.

17. The apparatus of claim 16, wherein the coil assembly includes a solenoid surrounding the plunger assembly enclosure.

18. The apparatus of claim 16 further comprising a plunger assembly that includes a plunger shaft coupled to a plunger.

19. The apparatus of claim 18, wherein the plunger assembly includes a plunger spring configured to apply a preload force on the plunger to prevent the plunger assembly from moving to a closed state.

20. The apparatus of claim 18, wherein the plunger and a flange have corresponding interfaces configured for magnetically attracting the flange and the plunger in response to application of an electric current to a coil of the coil assembly; and
wherein the coil is positioned such that when application of the electric current to the coil is removed, a force of energy stored in a plunger spring drives the plunger away from the flange.
